(19) United States
(12) Patent Application Publication
(10) Pub. No.: US 2022/0118599 A1
(43) Pub. Date: Apr. 21, 2022

(54) CUTTING IMPLEMENT HANDLE

(71) Applicant: Alfred Posnak, Hebron (CA)

(72) Inventor: Alfred Posnak, Hebron (CA)

(21) Appl. No.: 17/072,560

(22) Filed: Oct. 16, 2020

(51) Int. Cl. B25G 1/10

(52) U.S. Cl. CPC B25G 1/102

(57) ABSTRACT

A cutting implement handle that is configured to provide a user with an improved grip so as to facilitate a stronger engagement with a cutting implement. The cutting implement handle includes a body wherein the body includes a first side and a second side along with a top edge and a bottom edge. The body has formed on the second side a thumb engagement indentation that is angled towards the first end and configured to releasably secure a thumb. A plurality of phalangeal notches are formed on the bottom edge. One of the phalangeal notches is formed to engage a portion of the index finger of a user and includes an upper segment having a surface that is formed to progress inwards to the centerline of the body. An upper phalangeal groove is also present in the top edge and has a tapered surface.

### FIELD OF THE INVENTION

The present invention relates generally cutting implements such as but not limited to knives or cleavers, more specifically but not by way of limitation, a handle for a cutting implement wherein the handle includes elements that are operable to improve the control and stability of the engagement of the cutting implement.

### BACKGROUND

Millions of people utilize cutting implements on a daily basis. Cutting implements are available in a multitude of styles and shapes such as but not limited to knives and cleavers. The aforementioned implements are utilized to execute various different tasks and are commonly utilized in the kitchen. Working with cutting implements is inherently dangerous and thousands of minor to severe accidents occur every year. Individuals routinely cut themselves during use of a cutting implement and the root cause can range from wet surfaces, poorly prepared surfaces and the engagement with the cutting implement itself.

Cutting implements commonly have a singular handle design wherein the most common handles are flat in manner having opposing sides configured to have a user's hands wrap therearound. A few handles have some notches for fingers at the bottom thereof but not other feature of handles is present in existing technology that is configured to facilitate an improved grip so as to establish more control of a cutting implement during utilization thereof.

Accordingly, there is a need for a cutting implement handle that is configured to provide improved engagement thereof wherein the handle of the present invention includes grooves and notches for various phalangeal portions.

### SUMMARY OF THE INVENTION

It is the object of the present invention to provide a cutting implement handle that is formed to provide improved grip and control of a cutting implement wherein the present invention includes a body that is formed from a durable material such as but not limited to wood.

Another object of the present invention is to provide a cutting implement handle having a plurality of elements that engage phalangeal portions of a user's hand so as to improve the grip thereon wherein the body includes a first side and a second side.

A further object of the present invention is to provide a cutting implement handle that is formed to provide improved grip and control of a cutting implement wherein the first side includes a thumb engagement indentation that is configured to have a user's thumb therein and provide a desired position thereof.

Still another object of the present invention is to provide a cutting implement handle having a plurality of elements that engage phalangeal portions of a user's hand so as to improve the grip thereon wherein the second side of the body includes an index finger groove wherein the index finger groove extends from the top of the body and towards the bottom thereof.

An additional object of the present invention is to provide a cutting implement handle that is formed to provide improved grip and control of a cutting implement wherein the body includes a first end and second end wherein the first end is flared in form.

Yet a further object of the present invention is to provide a cutting implement handle having a plurality of elements that engage phalangeal portions of a user's hand so as to improve the grip thereon wherein the bottom edge of the body includes a plurality of phalangeal grooves formed therein.

Another object of the present invention is to provide a cutting implement handle that is formed to provide improved grip and control of a cutting implement wherein the index finger groove is angularly positioned so as to direct the index finger into one of the plurality of phalangeal grooves formed on the bottom.

Still another object of the present invention is to provide a cutting implement handle having a plurality of elements that engage phalangeal portions of a user's hand so as to improve the grip thereon wherein the thumb engagement indentation is angularly oriented towards the first end of the body.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a view of the second side of the body; and

FIG. 2 is a view of the first side of the body; and

FIG. 3 is a perspective view of the present invention being engaged by a user during the cutting process.

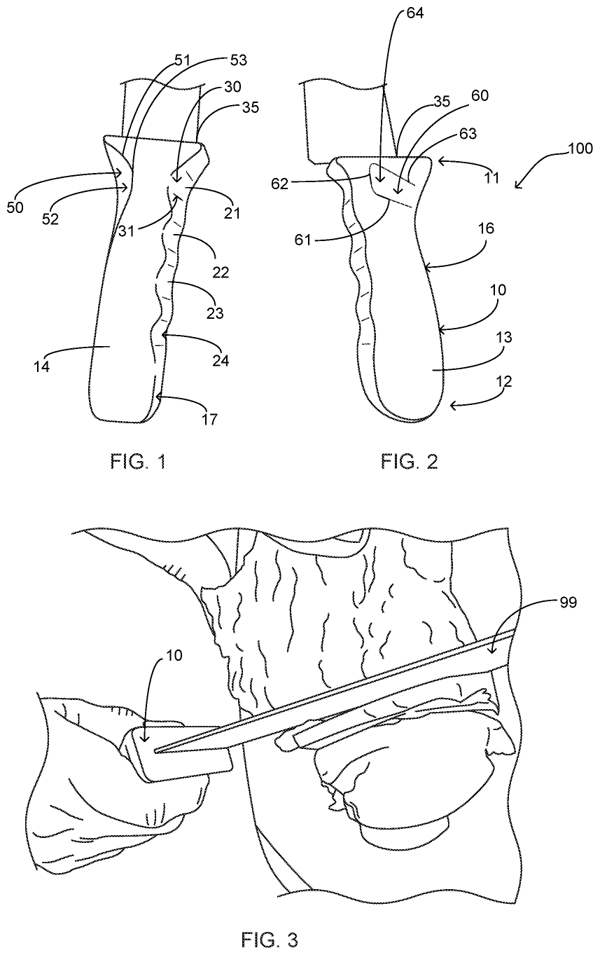

### DETAILED DESCRIPTION

Referring now to the drawings submitted herewith, wherein various elements depicted therein are not necessarily drawn to scale and wherein through the views and figures like elements are referenced with identical reference numerals, there is illustrated a cutting implement handle 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the cutting implement handle 100 includes body 10 that is manufactured from a durable rigid material such as but not limited to wood. The body 10 is operably coupled with exemplary blade 99 utilizing suitable durable techniques. The body 10 includes a first end 11 and second end 12 and further includes a first side 13 and second side 14. The body 10 is further formed to have top edge 16 and bottom edge 17.

Formed on the bottom edge 17 of the body 10 are a plurality of phalangeal notches 20. The plurality of phalangeal notches 20 are formed so as to receive four fingers of a user's hand. In the preferred embodiment illustrated herein, the plurality of phalangeal notches 20 include a first phalangeal notch 21, second phalangeal notch 22, third phalangeal notch 23 and fourth phalangeal notch 24 formed adjacent to each other. In the preferred embodiment illustrated herein, the first phalangeal notch 21 is configured to receive the index finger of the hand of the user, the second phalangeal notch 22 is configured to receive the middle finger of the hand of the user. While the third phalangeal notch 23 and fourth phalangeal notch 24 are configured to receive the third and fourth finger respectively. While four phalangeal notches have been described and illustrated herein it is contemplated within the scope of the present invention that the body 10 could have fewer than four phalangeal notches.

As discussed, the first phalangeal notch 21 is configured to operably engage the index finger of a user during engagement of the cutting implement handle 100. As is known in the art, the strength of a human hand grip is improved with a leveraged index finger and as such the construction of the first phalangeal notch 21 is designed to provide an improved grip on the body 10. The first phalangeal notch 21 includes an upper segment 30 having a surface 31 that is angled inwards towards a centerline of the body 10. The first phalangeal notch 21 is defined by upper perimeter edge 33 wherein the upper perimeter edge 33 has a greater radius that the other phalangeal notches and terminates at the top edge 35 being contiguous therewith. The first phalangeal notch 21 is angularly directed towards the first end 11 wherein this angle in conjunction with the upper segment 30 and surface 31 thereof combine to substantially inhibit a user's hand from sliding forward during utilization of the cutting implement handle 100.

An upper index phalangeal groove 50 is formed in the top edge 16 and further extending into the second side 14. The upper index phalangeal groove 50 is configured to operably couple with the base digit of the index finger of the hand engaged with the body 10. The upper index phalangeal groove 50 includes a lower perimeter edge 51 that is arcuate in form. The upper index phalangeal groove 50 includes a tapered surface 52 that tapers towards bottom area so as to direct the index finger into the desired position wherein the upper digits of the index finger will be aligned and engage with the first phalangeal notch 21. The depth of the tapered surface 52 is greater proximate the top edge 16 and more shallow as the surface progresses towards the bottom area 53.

Now referring to FIG. 2 herein the thumb engagement indentation 60 is formed in the first side 13 of the body 10. The thumb engagement indentation 60 is angularly positioned being angularly directed towards top edge 35. The angular orientation of the thumb engagement indentation 60 functions to further provide a stronger grip for a user's hand engaged with the body 10. The thumb engagement indentation 60 is defined by a lower edge 61, an upper edge 63 and a bottom edge 62 wherein the aforementioned are contiguous. The lower edge 61, upper edge 63 and bottom edge 62 define the thumb engagement indentation 60 and the lower surface 64 thereof operates in conjunction therewith to place the thumb in a more powerful leverage positioned based on the angular orientation of the thumb engagement indentation 60 and that the lower surface 64 is lower than that of the first side 13. It should be understood within the scope of the present invention that the thumb engagement indentation 60 could be provided at alternate angles and depths in order to achieve the desired objective of providing improved strength in the grip of the user engaged with the cutting implement handle 100.

The position of the thumb engagement indentation 60, upper index phalangeal groove 50 and the first phalangeal notch 21 as described herein provide a technique that substantially inhibits a user's hand from sliding towards the top edge 35 and further provides positioning for a stronger grip. As is known in the art, the percentage grip contribution to the strength of an overall grip for the index, middle, ring and small fingers are approximately 25%, 35%, 25% and 15% respectively. The aforementioned elements provide an improved technique of capitalizing on the source of strength of a human grip so as to provide a cutting implement handle 100 with superior benefits.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A cutting implement handle configured to facilitate an improved engagement thereof wherein the cutting implement handle comprises:
a body, said body having a first side and a second side, said body having a first end and a second end, said body having a top edge and a bottom edge, said first end being proximate a cutting blade;
a plurality of phalangeal notches, said plurality of phalangeal notches being formed in the bottom edge of said body, said plurality of phalangeal notches being arcuate in form and adjacent to each other, said plurality of phalangeal notches configured to operably engage fingers of a hand coupled with the cutting implement handle;
a thumb engagement indentation, said thumb engagement indentation formed in the first side of said body, said thumb engagement indentation being defined by a lower edge, an upper edge and a bottom edge wherein the lower edge, upper edge and bottom edge are contiguous, said thumb engagement indentation having a surface wherein said surface of said thumb engagement indentation is lower than that of an upper surface of the first side, said thumb engagement indentation being angularly oriented towards said first end of said body.

2. The cutting implement handle as recited in claim 1, and further including an upper index phalangeal groove, said upper index phalangeal groove being formed in the top edge and second side of the body, said upper index phalangeal groove being angled towards the first end of said body.

3. The cutting implement handle as recited in claim 2, wherein the upper index phalangeal groove has a tapered surface, wherein the tapered surface of the upper index phalangeal groove has a depth that is greater proximate the top edge of the body.

4. The cutting implement handle as recited in claim 3, wherein one of the plurality of phalangeal notches includes an upper segment having a surface that is angled towards a centerline of said body.

5. The cutting implement handle as recited in claim 4, wherein the plurality of phalangeal notches includes an index phalangeal notch that is proximate the first end and angularly oriented theretowards.

6. The cutting implement handle as recited in claim 5, wherein the index phalangeal notch includes an upper segment having a surface angled inwards towards the centerline of said body.

7. A cutting implement handle configured to facilitate a stronger grip during use of a cutting implement wherein the cutting implement handle comprises:
a body, said body being operably coupled to a cutting blade, said body having a first side and a second side, said body having a first end and a second end, said body having a top edge and a bottom edge, said first end being proximate said cutting blade;
four phalangeal notches, said four phalangeal notches being formed in the bottom edge of said body, said four phalangeal notches being arcuate in form and adjacent to each other, said four phalangeal notches including a first phalangeal notch, said first phalangeal notch being proximate said first end of said body, said first phalangeal notch having a radius that is largest of all said four phalangeal notches;
a thumb engagement indentation, said thumb engagement indentation formed in the first side of said body, said thumb engagement indentation being defined by a lower edge, an upper edge and a bottom edge wherein the lower edge, upper edge and bottom edge are contiguous, said thumb engagement indentation having a surface wherein said surface of said thumb engagement indentation is lower than that of an upper surface of the first side, said thumb engagement indentation being angularly oriented towards said first end of said body.

8. The cutting implement handle as recited in claim 7, wherein the first phalangeal notch includes an upper segment having a surface, wherein the surface of the upper segment is formed inwards towards a centerline of the body.

9. The cutting implement handle as recited in claim 8, wherein the first phalangeal notch is angularly oriented towards the first end of said body.

10. The cutting implement handle as recited in claim 9, and further including an upper index phalangeal groove, said upper index phalangeal groove being formed in the top edge and second side of the body, said upper index phalangeal groove being angled towards the first end of said body.

11. The cutting implement handle as recited in claim 10, wherein the upper index phalangeal groove has a tapered surface, wherein the tapered surface of the upper index phalangeal groove has a depth that is greater proximate the top edge of the body wherein the depth decreases along the tapered surface approaching a bottom area 53.

12. The cutting implement handle as recited in claim 11, wherein the upper index phalangeal groove includes an arcuate lower perimeter edge and is formed to engage a base digit of a human index finger.
